(19) United States
(12) Patent Application Publication
(10) Pub. No.: US 2008/0001736 A1
(43) Pub. Date: Jan. 3, 2008

(54) Electronic Circuit

(75) Inventors: Roger Steadman, Aachen (DE); Thomas Duerbaum, Baiersdorf (DE); Francisco Morales Serrano, Eindhoven (NL); Gereon Vogtmier, Aachen (DE)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N.V., Eindhoven (NL)

(21) Appl. No.: 11/570,103

(22) PCT Filed: Jun. 1, 2005
(86) PCT No.: PCT/IB05/51776

§ 371 Date: Dec. 6, 2006

(30) Foreign Application Priority Data
Jun. 9, 2004 (EP) 04102632.9

(51) Int. Cl. G08B 21/00

(52) U.S. Cl. 340/540

(57) ABSTRACT

The present invention relates to an electronic circuit for reading out a plurality of sensor elements while disadvantages like degradation of analog signal transfer is avoided. The electronic circuit comprises a plurality of sensor elements (1, 11, 1-2, . . . ), each having at least a first and a second state and an output that conveys a trigger signal when the sensor element (1, 1-1, 1-2, . . . ) switches from the first state to the second state, a plurality of registers (R-1, R-2, . . . ) that are coupled to the outputs of the sensor elements (1, 1-1, 1-2, . . . ), a counter (CNT) that in an active state conveys a counter signal that is changing with a given clock rate, means for storing the counter signal into one of the registers (R1) when the trigger signal of one of the sensor elements (1-1 Y is received, and means for uniquely assigning the stored counter signal to the triggering sensor element (1-1).

The present invention concerns an electronic circuit for the readout of a plurality of sensor elements, particularly of sensor elements arranged in a rectangular or hexagonal matrix. Such matrices of sensor elements are often used in imaging devices, i.e. optical imagers (e.g. CCD cameras) or X-ray imagers (e.g. flat, semiconductor-based X-ray detectors).

The readout of such pluralities of sensor elements can be accomplished as follows. Minimal electronics are realized at the sensor elements and analog signals, e.g. the integrated signal received by each sensor element during a given sensing period, are transferred to electronics, which lie outside the sensitive area, that amplify, digitize and process the signals. The transfer of analog signals, especially if the matrix of sensors is large and/or the consecutive sensing periods are short, is affected by electronic crosstalk, electronic noise etc.

It is therefore an object of the invention to provide an electronic circuit that allows reading out a plurality of sensor elements while circumventing the disadvantages of the known read-out circuit.

The object is solved by an electronic circuit comprising a plurality of sensor elements, each having at least a first and a second state and an output that conveys a trigger signal when the sensor element switches from the first state to the second state, a plurality of registers that are coupled to the outputs of the sensor elements, a counter that in an active state conveys a counter signal that is changing with a given clock rate, means for storing the counter signal into one of the registers when the trigger signal of one of the sensor elements is received, and means for uniquely assigning the stored counter signal to the triggering sensor element.

In one embodiment of the invention, the means for uniquely assigning the stored counter signal comprise a unique physical coupling of the registers to the outputs of sensor elements. This can be easily accomplished by e.g. a hardwired, direct connection between each register to a given sensor element. As a consequence, the value stored in the respective register is always directly assigned to the connected sensor element.

In another embodiment of the invention, the means for uniquely assigning the stored counter signal comprise means for providing a sensor element identification tag that is stored with the counter signal. This can e.g. be accomplished by transferring the trigger signal along with two orthogonal lines that uniquely define the position of the triggering element in a sensor element matrix. This information can be used to generate position information, which is as identification tag stored together with the counter value.

In a further embodiment of the invention, at least a subgroup of sensor elements are formed on a connected area on a substrate and the respective registers to which the sensor elements are coupled are formed outside this area. As the sensor elements are only accompanied by minimal electronics, optimal use can be made of the available area. The area not covered by the sensitive part of the sensor element can thus be minimized.

In one embodiment of the invention, at least one sensor element is an integrating sensor element that has a first state and a second state. In the first state the sensor element integrates the sensor signal and in a second state the sensor element is in an idle state. The switching from the first state into the second state is induced when the integrated sensor signal reaches a threshold value. The trigger signal that is conveyed at the instant of the switching then relates to the time instant at which the integrated sensor signal has reached the threshold value.

In another embodiment, the sensor element is not integrating but comparing the sensor signal relating to the electronic current provided by the sensor with a threshold value. If the sensor signal reaches the threshold value, the sensor switches into the second state and the trigger signal is conveyed. In this embodiment, the trigger signal then relates to the time instant at which the electronic current has reached the threshold value.

In a further design of the before described embodiment, the integrating sensor element has two integration constants in the first state. This allows for using a larger dynamic range. If the threshold value is reached within a short time period, the second (lower) integration constant is switched on and the integrated signal is affected by a relatively lower noise content as the sensor signal is integrated over a longer period. In a further embodiment, the integrating sensor element has a second output for conveying a gain signal that represents information on the integration process. In a preferred embodiment, this information relates to the applied integration constant.

In another embodiment of the invention, the clock rate is decreasing. This allows using high clock rates at the beginning of the sensing period and a lower clock rate at the end of a sensing period. This allows for having a higher resolution of the read-out process at the beginning while reducing (or keeping constant) the number of counter bits.

The invention also relates to an imaging device that utilizes the inventive electronic circuit. Such an imaging device could be an optical imager (e.g. a CCD-based camera) or a medical imaging device for acquiring X-ray images. In both cases photo diodes could be used as sensor elements, as in the latter case a conversion layer could be applied that converts X-rays into optical quanta. X-ray imagers are used in radiographic imaging, in fluoroscopic (dynamic) imaging or in a Computed Tomography (CT) system. Current CT systems do have so-called multi-line imagers (or detectors), so that in a single circular acquisition, several cross-sectional slices through the imaged object can be generated.

The invention also relates to a method for reading out a plurality of sensor elements.

A register could be a single storage unit, it could be part of addressable memory unit or it could consist of two or more memory storage parts, where one part is used for storing the counter value and another part is used to store additional information, e.g. sensor element identification information and/or gain information.

A trigger signal could be a short trigger pulse or the change in a previously constant signal.

These and other aspects of the invention will be apparent from and elucidated with reference to the embodiments described hereinafter and with reference to the drawings, in which

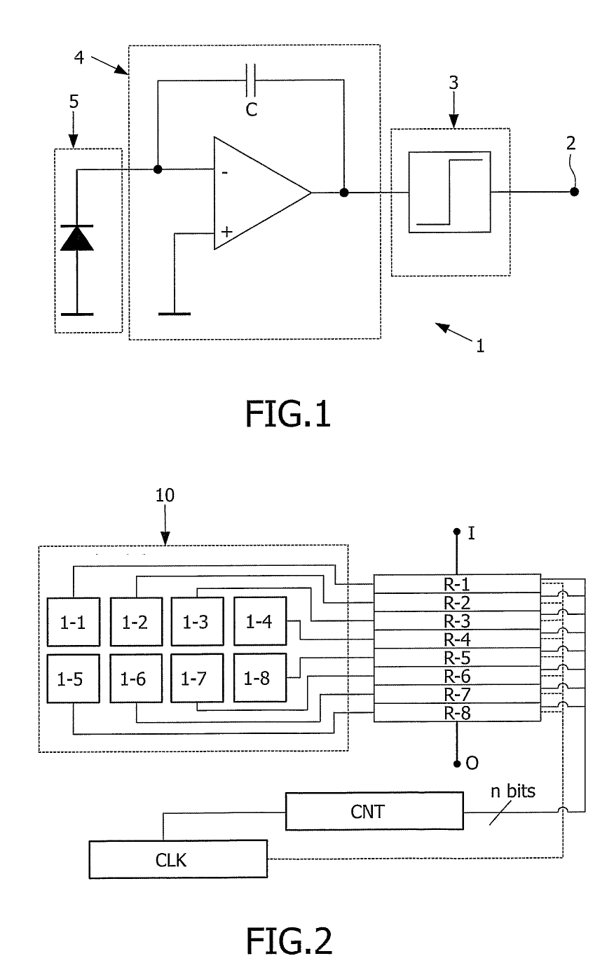

FIG. 1 is a schematic depiction of an exemplary embodiment of a sensor element,

FIG. 2 is a schematic depiction of an exemplary electronic circuit according to the invention,

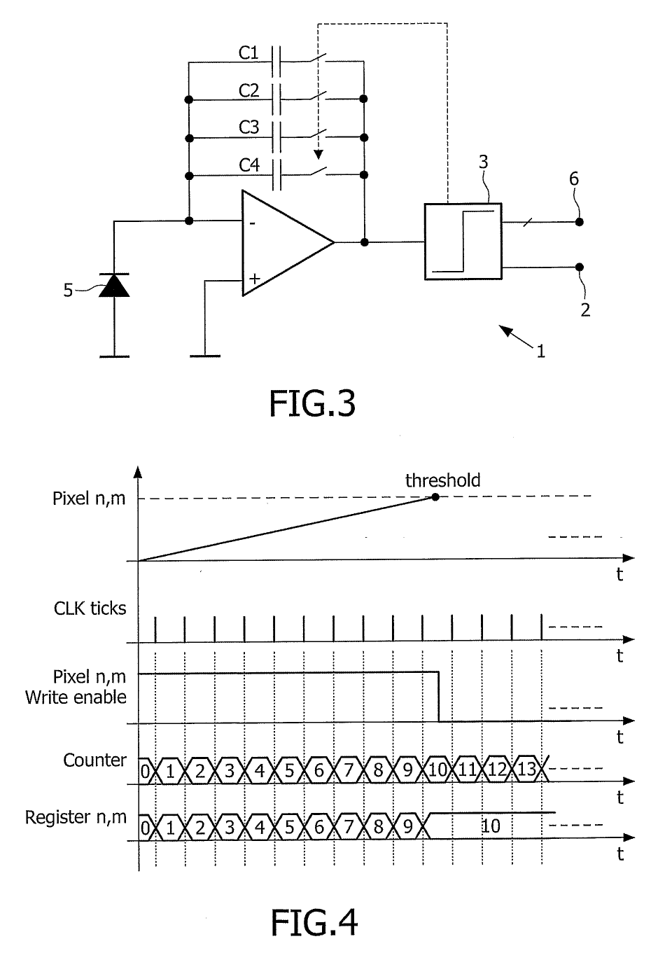

FIG. 3 is a schematic depiction of a second exemplary embodiment of a single sensor element, and

FIG. 4 a time flow diagram of various signals according to one embodiment of an inventive circuit.

FIG. 1 depicts a single sensor element 1 according to a first embodiment. The single sensor element 1 comprises an output 2 at which a trigger signal can be provided. It furthermore comprises a comparator section 3, a sensor signal integrating section 4 and a sensing section 5. In the shown embodiment, the sensing section 5 is realized as a photo diode. Photo diodes can be used to detect optical quanta, e.g. visible light, IR (infra-red) light or UV (ultra violet) light, depending on the spectral sensitivity of the photo diode made from a semi-conductor material. Hence, a photo diode can be used in an optical imager like a CCD camera or in an X-ray imager. In the latter case, a scintillator is used to convert the X-ray quanta into the optical quanta that are then sensed by the photo diode. The optical quanta impinging on the photo diode generate free electrons when interacting with the semi-conductor material, which electrons are cumulated in the integrating section 4, which integration state is the first state of the shown sensor element 1. In the shown embodiment, the integrating section 4 includes an operation amplifier and a capacity C. In the comparator section 3 the comparator electronics compares the integrated sensor signal with a threshold value. In case the integrated sensor signal equals the threshold value, the sensor element 1 switches into a second state, e.g. it stops integrating and is then in an idle state. A trigger signal is provided at the output 2 at the instance of the switching from the first state into the second state. The trigger signal can be realized as a simple 1-Bit signal, i.e. as a high/low voltage output. When the threshold value is reached, the output is switched from high voltage to low voltage or vice versa. In another embodiment, a trigger pulse in conveyed instead of switching from one voltage to another.

FIG. 2 shows an exemplary embodiment of an inventive electronic circuit comprising eight sensor elements 1-1 to 1-8. In this embodiment, the output of each of the sensor elements 1-1 to 1-8 is uniquely coupled to one of the registers R-1 to R-8 in a one-to-one manner. The electronic circuit furthermore comprises a clock CLK that at a given clock rate generates clock pulses that are applied to a counter CNT and to the registers R-1 to R-8. The counter CNT generates a counter signal that changes with the clock-rate, e.g. the counter signal is incremented by 1 at each clock signal. The counter signal is conveyed to each of the registers in a synchronized manner, so that at a given instant the same counter value is applied at each register. In the shown embodiment, the counter value is incremented at every clock pulse.

In one embodiment, the counter signal is a 17 bit digital counter that starts at zero and is incremented with every clock pulse. A resolution of 17 bit is usually sufficing for multi-line Computed Tomography (CT), where e.g. a maximum signal of about 1.000.000 quanta is expected on a 1×1 mm² sensor area per millisecond (these values of course depend on the CT system geometry, the application etc. and the given numbers should not be interpreted in a limiting sense). A noise signal of 8 quanta should then be resolved. This requires a relative resolution of 125.000, which is covered by a 17-bit counter signal (2¹⁷=131.072). In one embodiment, the clock rate is constant and is chosen so that the highest counter value is reached at the end of a given sensing period (in the discussed example, this would be 1 ms). For other applications, like regular optical imaging, a 8 bit or 10 bit counter signal would be sufficient; for normal X-ray radiography, a 12 bit counter would suffice. The bit depth of the counter signal is therefore dependent on the application and can vary accordingly. It is to be understood that the given examples should not be interpreted in a limiting sense.

The read out of the sensor elements 1-1, 1-2, . . . , 1-8 is accomplished as follows. When the sensing period starts (the sensor element are set to their first state at the beginning of the sensing period), the sensor signal that is generated in the photo diode 5 is integrated in the integration section 4 and the integrated signal is compared with the threshold value in the comparator section 3. In the described embodiment, the threshold value is chosen as the lowest signal that needs to be resolved. For CT, as described above, the lowest signal to be expected is about 64 quanta (which leads to a 8 quanta noise signal). The threshold value is then set to an electronic value representing 64 quanta. In the case that the lowest quantum flow that should be resolved to its noise level (64 quanta per sensing period) is impinging on the sensor element, the threshold value will be reached at the end of the sensing period. In the case that the highest expected quantum flow (1.000.000 quanta per sensing period) is impinging on the sensor element, the threshold value is reached within about 8 clock cycles. Whenever the threshold value is reached, the sensor element switches into the second state. In the shown embodiment, the sensor element stops integrating and neglects further incoming quanta; the second state is an idle state.

At the instance of switching from the first state to the second state, the sensor element provides a trigger signal at its output and the trigger signal is conveyed to the receiving element that is coupled to the output 2. In the shown embodiment, the receiving element is a uniquely coupled register. The trigger signal causes the uniquely coupled register to store the current counter value that is applied at the register at this instant. This storage process can happen by storing the counter signals at each clock pulse into the registers and inhibiting further overwriting when the trigger signal is received. In this embodiment, the respective trigger signal is switched from “write enable” to “write disable” when the sensor switches into its second state. In another embodiment, the counter signal is provided at the registers but not stored at each clock pulse (in this case, the clock pulse does not need to be conveyed to each register). Storage is then only initiated in case the trigger signal is received. In this period, each clock signal (or clock tick) causes the applied counter signal to be stored in the registers. If a sensor element switches into the second state, its trigger signal is switched to a low voltage (write disable) and further storage of counter values into the respective register coupled to this triggering sensor element is inhibited.

As the length of the sensing period is known, the total signal that has impinged on the sensor element 1-1, 1-2, . . . , 1-8 during the sensing period can be estimated by linear interpolation. As each of the registers R-1, R-2, . . . , R-8 is uniquely assigned to a sensor element and has stored the signal counter value at which the sensor element had integrated a signal equaling a given threshold signal, the time at which the threshold value was reached can be derived (derived threshold time=(signal counter value) divided by (maximum signal counter value) times (sensing period time)) for each sensor element. The total signal is computed by multiplying the threshold signal by the ratio of derived threshold time and time length of the sensing period (or by the stored signal counter value divided by the maximum signal counter value).

In a CT acquisition as described a sensing period is about 1 ms, which requires a clock rate of about 130 MHz to increment a 17 bit counter during the sensing period (in modern CT devices about 2000 projections are acquired during a 0.3 s rotation period which would require a 780 MHz clock rate). It is apparent that an improved signal accuracy can be achieved by a higher clock rate and a larger counter, e.g. by a 20 bit counter and an according clock rate of about 1.04 GHz. It is also apparent that the above given numbers for CT are simple examples and should not restrict the invention. It is also clear that the discussion above may be varied when taking into account manufacturing tolerances, noise considerations etc.

In an extension of the embodiments discussed with reference to FIGS. 1 and 2, other embodiments are possible. E.g. it must not be necessary that each sensor element is uniquely coupled to a register. Evidently, it is also possible to identify the triggering sensor element electronically and to store the current counter value at the triggering instance together with an identification tag in one of the registers. The unique coupling only avoids additional identification electronics.

FIG. 3 shows another embodiment of a sensor element. In this sensor element, several integration capacities are present, whereby C1<C2<C3<C4. In the first state the sensor element initially starts integrating the sensor signal with the smallest integration capacity C1. The comparator 3 compares the voltage output of the integrating section with the threshold value, whereby the voltage output of the integrating section relates to the ratio of the integrated signal over the integration capacity. In case of a high sensor signal, the threshold value would be achieved within a time period very short to the sensing period. Then the comparator section 3 affects the integrating section so that the next largest integration capacity C2 is switched on. This results in a reduction of the voltage output of the integrating section as C2 has a higher integration capacity than C1. In case that the threshold value is again reached within a time short to the sensing period, the comparator affects again the integrating section and switches on the next largest integration capacity C3. In order to judge if the next largest integration capacity shall be switched on, the ratio of the current sensing time over the total sensing period is compared with the increase in the integration capacity. If e.g. the integration capacities differ by a factor of four, the switch is initiated if the ratio of the current sensing time over the total sensing period is lower than 0.25 as otherwise there would be a high probability that the threshold value is not reached within the sensing period. Additionally, one may apply a security buffer, so that switching of the integration capacity is only initiated if the ratio of the current sensing time over the total sensing period is lower than e.g. 0.20 (or any other ratio lower than 0.25 for the given example).

If a threshold value is reached within a short time due to a high quantum inflow, quantum statistics of the measured value can be improved by switching on another capacity, so that another integration constant is used. The same threshold value is used in the comparator 3 but the amplification applied in the integrating section 4 is lower, as the integration capacity defines the maximum voltage output. Therefore, it needs more time to reach the threshold value. The number of measured quanta is increased and therefore the Poisson noise of the measured value is reduced with respect to the absolute quantum count. Besides an embodiment with one additional integration capacity, embodiments with several switchable integration capacities can be used. In FIG. 3 an embodiment with four different integration capacities C1, C2, C3, and C4 is shown. The integration capacities can be designed to decrease the integration constant by a factor of 1, 4, 16, 64, so that each capacity decreases the integration constant by a factor of 4. These integration constants are also called gain settings. Other settings are of course possible, e.g. a capacity chain representing integration constants of 1, 2, 4, 8 or 1, 8, 64, 512. Also non-regular factors can be used, e.g. a capacity chain representing integration factors (or gain settings) of 1, 2, 8, 128.

In some cases it might not be necessary to communicate the gain setting. In some applications a sudden change in neighboring sensor element values is not expected (e.g. low contrast imaging or imaging with a certain smoothing, e.g. introduced by a conversion layer on top of the sensor element matrix). In these cases, the switching of the gain value can be derived from noticeable steps in the sensor element values. In other cases such an indirect derivation of the gain factor is not possible. Then the gain setting of the sensor element needs to be communicated to the outside electronics in order to apply the right factor when computing the total signal that would have been seen during the whole sensing period. In FIG. 3 the shown sensor element has an additional output 6 for providing information on the integration process, notably the gain setting. In the given embodiment with four integration capacities the output 6 could be a two bit digital output or it could be an analog output that provides an analog voltage signal, the voltage level representing the gain setting. The gain setting is stored together with the current counter signal when the register receives the trigger signal. In such an embodiment, a register consists of a counter memory and a gain setting memory (and a identification tag memory in case that the unique assignment is not realized e.g. by hardwired connections).

FIG. 4 shows a time-flow diagram of various signals according to one embodiment of an inventive electronic circuit. The uppermost signal curve (Pixel n,m) shows the signal that is integrated in a given sensor element 1 until the integrated signal reaches a threshold value. The sensor element 1 then switches into an idle state. The second graph (CLK ticks) shows the clock signals (or ticks) that are applied to the registers R-1, R-2 . . . . In the shown embodiment, the clock ticks are generated at a constant clock rate. The third graphs shows the write enable signal value (Pixel n,m Write enable) generated by sensor element 1 and applied to register R-1. The fourth and fifth signal graphs show the value of the counter signal (Counter) and the value that is stored in the register R-1 (Register n,m), which in the current embodiment is assumed to be directly connected (hardwired) to the sensor element 1, so that the stored value is directly assigned to the respective sensor element. At the instant at which the sensor element switches from the first state (integrating state) into the second state (idle state), the write enable signal is switched off. During the first state, each clock tick induced the storage of the applied counter value into the register R-1. When the write enable signal is switched off, a subsequent clock tick does not result in the storage of the applied counter value into the register R-1. Therefore, the counter value that is stored in register R-1 indicates the time at which the sensor element 1 has reached the threshold value.

1. Electronic circuit comprising
a plurality of sensor elements, each having at least a first and a second state and an output that conveys a trigger signal when the sensor element switches from the first state to the second state,
a plurality of registers that are coupled to the outputs of the sensor elements,
a counter that in an active state conveys a counter signal that is changing with a given clock rate,
means for storing the counter signal into one of the registers when the trigger signal of one of the sensor elements is received, and
means for uniquely assigning the stored counter signal to the triggering sensor element.

2. Electronic circuit according to claim 1, wherein the means for uniquely assigning the stored counter signal comprise a unique physical coupling of the registers to the outputs of the sensor elements.

3. Electronic circuit according to claim 1, wherein the means for uniquely assigning the stored counter signal comprise means for providing a sensor element identification tag that is stored with the counter signal.

4. Electronic circuit according to claim 1, wherein it has a substrate, where on a connected area of the substrate at least a subgroup of the sensor elements is formed and where the registers to which the subgroup of sensor elements is coupled are formed outside the area.

5. Electronic circuit according to claim 1, wherein at least one of the sensor elements is an integrating sensor element that in the first state integrates a sensor signal and in the second state is in an idle state, where said integrating sensor element is switching from the first state into the second state when the integrated sensor signal has reached a given threshold value.

6. Electronic circuit according to claim 5, wherein the integrating sensor element has at least two integration constants in the first state.

7. Electronic circuit according to claim 5, wherein the integrating sensor element has a second output arranged to convey a gain signal, the gain signal representing information on the integration process, notably information on the applied integration constant.

8. Electronic circuit according to claim 1, wherein the clock rate is decreasing with time.

9. Imaging device wherein it utilizes an electronic circuit according to claim 1.

10. Method for reading out a plurality of sensor elements, comprising the steps of:
sensing in each sensor element a respective sensor signal while being in a first state,
switching of a sensor element into a second state when a given condition is reached,
conveying a trigger signal at the instance of the switching,
providing a counter signal indicative of the switching time,
a storing the counter signal,
uniquely assigning the stored counter signal to the triggering sensor element.
